(19) United States
(12) Patent Application Publication
(10) Pub. No.: US 2007/0095031 A1
(43) Pub. Date: May 3, 2007

(54) Mounting collar for a filter bag

(76) Inventor: Terry L. Zahuranec, North Olmsted, OH (US)

Correspondence Address: PATENT GROUP 2N;JONES DAY, NORTH POINT, 901 LAKESIDE AVENUE, CLEVELAND, OH, 44114, US

(21) Appl. No.: 11/266,160

(22) Filed: Nov. 3, 2005

(51) Int. Cl. B01D 46/00

(52) U.S. Cl. 55/374

(57) ABSTRACT

A filter bag apparatus includes a filter bag and a panel. The panel is adhered to the bag and has an opening configured to receive a fill tube for the fill tube to exhaust dirt laden air into the bag. The opening has notches configured to pass over ears of the fill tube and then rotate out of alignment with the notches to capture the panel behind the ears to mount the bag to the fill tube. The panel has a longest dimension and a shortest dimension perpendicular to the longest dimension.

### TECHNICAL FIELD

The present invention relates to filter bags for vacuum cleaners.

### BACKGROUND

A vacuum cleaner generates an air flow that carries dirt from a household surfaces into a filter bag. The filter bag has a mounting collar with an opening that provides access to the interior of the bag. The bag is removably mounted on a fill tube of the vacuum cleaner by insertion of the fill tube through the opening in the collar.

### SUMMARY

A filter bag apparatus includes a filter bag and a panel. The panel is adhered to the bag and has an opening configured to receive a fill tube for the fill tube to exhaust dirt laden air into the bag. The opening has notches configured to pass over ears of the fill tube and then rotate out of alignment with the notches to capture the panel behind the ears to mount the bag to the fill tube. The panel has a longest dimension and a shortest dimension perpendicular to the longest dimension.

Preferably, the panel has only one longest dimension. The longest dimension is inclined with respect to both the length and the width of the bag. The longest dimension is parallel to an axis about which each notch is centered. The panel opening is centered on an axis about which each notch is centered. The outer edge of the panel has opposite straight sections that are parallel with the longest dimension. The outer edge of the panel is rounded outward at each of its most distantly separated points.

### BRIEF DESCRIPTION OF THE DRAWINGS

FIG. 1 is a perspective view a filter bag assembly and a vacuum cleaner fill tube used with the assembly; and

FIG. 2 is a front view of the bag assembly.

### DESCRIPTION

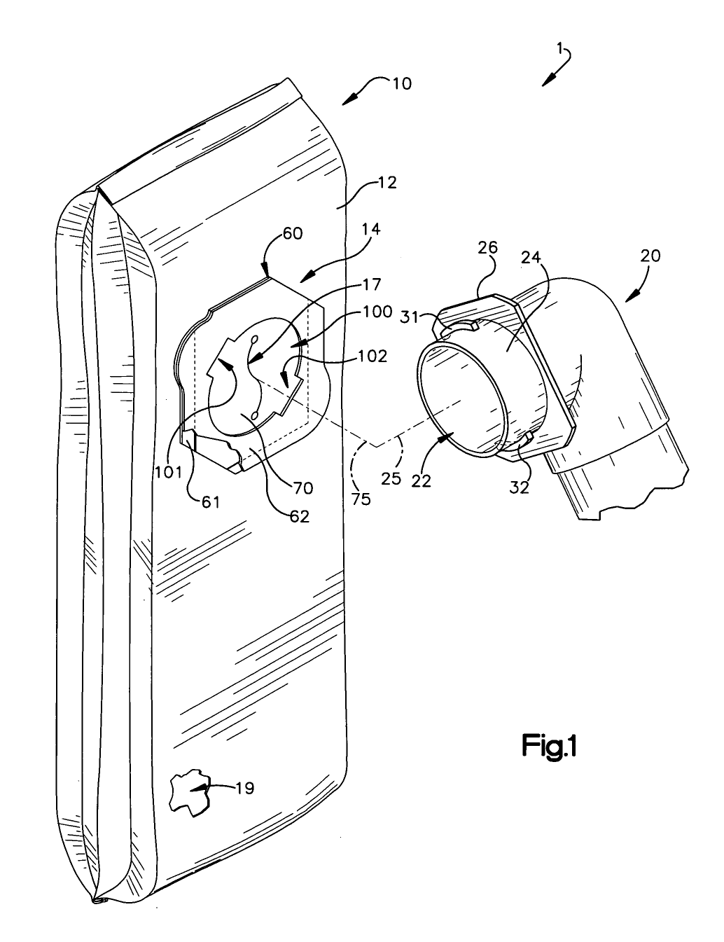

The apparatus 1 shown in FIG. 1 has parts that are examples of the elements recited in the claims. The apparatus thus includes examples of how a person of ordinary skill in the art can make and use the claimed invention. It is described here to meet the requirements of enablement and best mode without imposing limitations that are not recited in the claims.

The apparatus 1 includes a disposable vacuum cleaner filter bag assembly 10. The assembly 10 has a filter bag 12, of paper-like porous filter material, and a mounting collar 14 adhered to the bag 12. The collar 14 has an opening 17 that provides access to the interior 19 of the bag 12. The bag assembly 10 is removably mounted on a fill tube 20 of a vacuum cleaner by insertion of the fill tube 20 through the collar 14.

The fill tube 20 includes a front opening 22 through which the vacuum cleaner exhausts dirt laden air into the bag 12. The fill tube 20 further includes a cylindrical outer surface 24 centered on an axis 25. A back plate 26 extends radially outward from the cylindrical surface 22 about the full circumference of the cylindrical surface 22. Upper and lower ears 31 and 32 project radially outward from diametrically opposite sides of the cylindrical surface 22.

The collar 14 has a rigid panel 60 formed of two paperboard plates 61 and 62 adhered together, with an elastic diaphragm 70 sandwiched in-between. The diaphragm 70 has an S-shaped slit defining the bag opening 17.

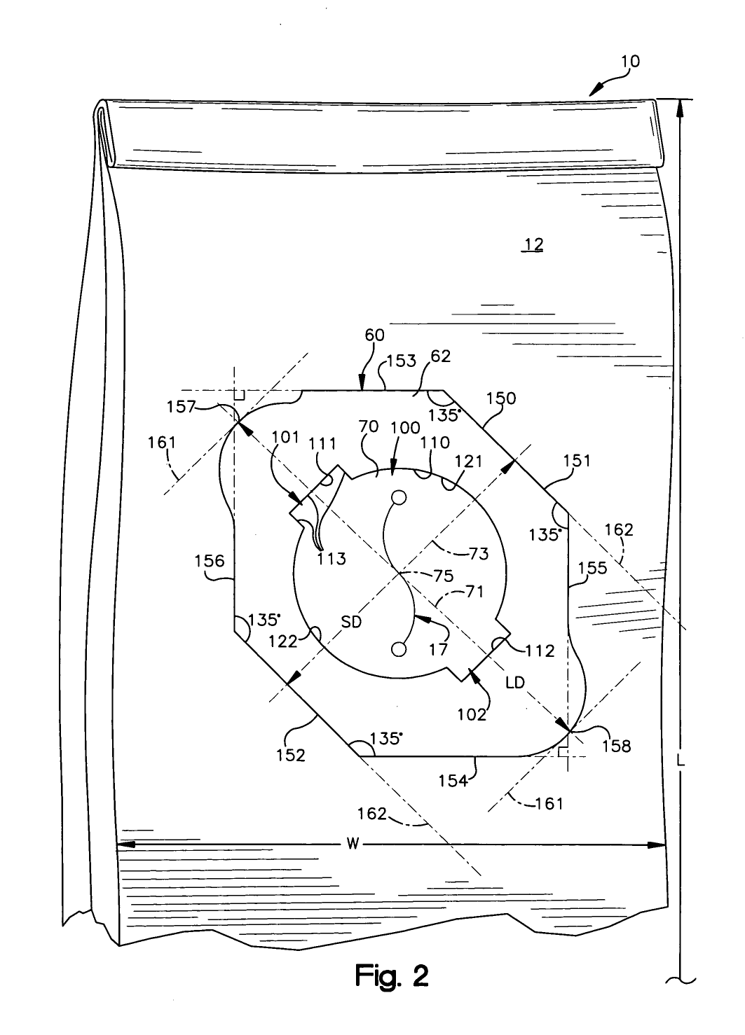

As shown in FIG. 2, the panel 60 is located on perpendicular longitudinal and transverse axes 71 and 73 that intersect at a center point 75. The panel 60 is elongated along the longitudinal axis 71.

The panel 60 has a generally round opening 100 that is centered on the center point 75 and has first and second longitudinally opposite notches 101 and 102. The notches 101 and 102 are identical and mutually symmetric about the center point 75. Each notch 101 and 102 is symmetric about the longitudinal axis 71.

The opening 100 is defined by a closed inner edge 110 of the panel 60. The inner edge 110 has two longitudinally opposite rectangular sections 111 and 112 respectively defining the two notches 101 and 102. Each rectangular section 111 and 112 consists of three straight edges 113. The inner edge 110 further has two transversely opposite circular sections 121 and 122 that are identical and mutually symmetric about the center point 75. The circular sections 121 and 122 define a circular shape that is centered on the center point 75 and diametrically larger than the cylindrical surface 24 (FIG. 1) of the fill tube 20. Each circular section 121 and 122 extends from the first notch section 111 to the second notch section 112.

The panel 70 further has a closed outer edge 150. The outer edge 150 has first and second straight sections 151 and 152 that are parallel with the longitudinal axis 71. It also has third and fourth parallel straight sections 153 and 154 that meet the first and second straight sections 151 and 152 at 135° angles, and fifth and sixth parallel straight sections 155 and 156 that meet the first and second straight sections 151 and 152 at 135° angles. None of the straight sections 151-156 is parallel with the transverse axis 73 or extends along longitudinally outermost locations 157 and 158 of the panel 60. The outer edge 150 is outwardly rounded at the longitudinally outermost locations 157 and 158.

A longest dimension LD of the panel 60 is defined by the most-distantly-spaced pair of parallel borderlines 161 that border the panel 60 without intersecting it, with the longest dimension LD extending perpendicularly from one borderline 161 to the other. Similarly, a shortest dimension SD of the panel 60 is defined by the least-distantly-spaced pair of parallel borderlines 162 that border the panel 60 without intersecting it, with the shortest dimension SD extending perpendicularly from one borderline 162 to the other. In this example, there is only one longest dimension LD and only one shortest dimension SD. The longest dimension LD is perpendicular to the shortest dimension SD. The longest dimension LD is parallel with the axis 71 about which the panel opening 100 and each of its notches 101 and 102 are centered. The longest dimension LD is inclined relative to the length L and width W of the bag 12, preferably at an angle of about 45° relative to the length L of the bag 12.

With reference to FIG. 1, the bag assembly 10 can be mounted on the fill tube 20 as follows. First, the panel 60 is positioned in front of the fill tube 20, with the panel opening 100 facing the fill tube opening 22 and the notches 101 and 102 circumferentially aligned with the ears 31 and 32. Next, the ears 31 and 32 pass through the notches 101 and 102 as the fill tube 20 is inserted through the panel opening 100 and the diaphragm opening 17 into the bag 12. The panel 60 is then rotated about its axis 75 relative to the fill tube 20 to rotate the notches 101 and 102 out of alignment with the ears 31 and 32, for the panel 60 to be captured between the ears 31 and 32 and the back plate 26. The diaphragm 70 forms a seal with the cylindrical surface 24 about the full circumference of the surface 24. The bag assembly 10 is thus mounted condition on the fill tube 20.

In this mounting procedure, rotation of the collar 14 relative to the tube 20 is equivalent to rotation of the tube 20 relative to the collar 14. When the notches 101 and 102 are aligned with the ears 31 and 32, the bag's length L is inclined at a 45° angle and the collar's longitudinal axis 71 is vertical. After the bag 12 is brought into its mounted position, the bag's length L is vertical and the collar's longitudinal axis 71 is inclined at a 45° angle.

The bag assembly 10 can be removed from the fill tube 20 by rotating the collar 60 until the notches 101 and 102 are aligned with the ears 31 and 32. The ears 31 and 32 can then pass through the notches 101 and 102 as the tube 20 is withdrawn from the panel opening 100.

The procedures for mounting and removing the bag assembly 10 are facilitated by the features described above relating to the longest dimension LD. Relative to conventional mounting collars, the present mounting collar 10 is easier to grasp and overcome friction of the diaphragm 70 with the fill tube 20 when forcing the collar 14 over the fill tube 20 and rotating the collar 14 about the fill tube 20. The orientations of the straight sections 151, 152, 153, 154, 155 and 156 relative to each other and to the long dimension LD minimizes the clearance required between the collar 14 and adjacent vacuum cleaner parts for rotating the collar 14. Since the length L and width W of the bag 12 are inclined at a 45° angle relative to both the longest dimension LD of the collar 14 and the fill tube ears 131 and 132 when the collar 14 is being mounted, the longest dimension LD of the collar 14 is aligned with the ears 31 and 32 when the collar 14 is being mounted.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. A filter bag apparatus comprising:
a filter bag; and
a panel adhered to the bag and having an opening configured to receive a fill tube for the fill tube to exhaust dirt laden air into the bag, the opening having notches configured to pass over ears of the fill tube and then rotate out of alignment with the ears to capture the panel behind the ears to mount the bag to the fill tube, the panel having a longest dimension and a shortest dimension perpendicular to the longest dimension.

2. The apparatus of claim 1 wherein the panel has only one longest dimension.

3. The apparatus of claim 1 wherein the longest dimension is inclined with respect to both the length and the width of the bag.

4. The apparatus of claim 1 wherein the longest dimension is parallel to an axis about which each notch is centered.

5. The apparatus of claim 1 wherein the panel opening is centered on an axis about which each notch is centered.

6. The apparatus of claim 1 wherein the outer edge of the panel has opposite straight sections that are parallel with the longest dimension.

7. The apparatus of claim 1 wherein the outer edge of the panel is rounded outward at each of its most distantly separated points.

8. A filter bag apparatus comprising:
a filter bag; and
a panel adhered to the bag and having an opening configured to receive a fill tube for the fill tube to exhaust dirt laden air into the bag, the opening having notches configured to pass over ears of the fill tube and rotate out of alignment with the ears to capture the panel behind the ears to mount the bag to the fill tube, the panel having only one longest dimension, which is parallel to an axis about which each notch is centered.

9. The apparatus of claim 8 wherein the longest dimension is inclined with respect to both the length and the width of the bag.

10. The apparatus of claim 8 wherein the panel opening is centered on the axis about which each notch is centered.

11. The apparatus of claim 8 wherein the outer edge includes two transversely opposite straight sections that are parallel with the axis about which each notch is centered.

12. The apparatus of claim 8 wherein the outer edge of the panel is rounded outward at each of its most distantly separated points.

13. A filter bag apparatus comprising:
a filter bag; and
a panel adhered to the bag and having an opening configured to receive a fill tube for the fill tube to exhaust dirt laden air into the bag, the opening having notches configured to pass over ears of the fill tube and rotate out of alignment with the ears to capture the panel behind the ears to mount the bag to the fill tube, the panel having only one longest dimension, which is inclined with respect to both the length and the width of the bag.

14. The apparatus of claim 13 wherein the longest dimension is inclined at an angle of about 45° relative to the length of the bag.
